(19) United States
(12) Patent Application Publication
(10) Pub. No.: US 2023/0306307 A1
(43) Pub. Date: Sep. 28, 2023

(54) SYSTEMS AND METHODS FOR PROVISIONING ARTIFICIAL INTELLIGENCE RESOURCES

(71) Applicant: Acronis International GmbH, Schaffhausen (CH)

(72) Inventors: Sergey Ulasen, Moscow (RU); Alexander Tormasov, Moscow (RU); Serg Bell, Costa Del Sol (SG); Stanislav Protasov, Singapore (SG)

(21) Appl. No.: 18/159,164

(22) Filed: Jan. 25, 2023

Related U.S. Application Data
(60) Provisional application No. 63/322,308, filed on Mar. 22, 2022.

(51) Int. Cl. G06N 20/00

(52) U.S. Cl. CPC G06N 20/00

(57) ABSTRACT

Disclosed herein are systems and method for provisioning artificial intelligence resources. A method may receive an input training dataset and an indication of a task to perform using the input training dataset and may determine a size of the input dataset and a content type of an entry in the input training dataset. The method may identify, from a plurality of computing resources, at least one computing resource to accommodate the size and the content type associated with the input training dataset and may identify attributes of the input training dataset. The method may select, from a plurality of artificial intelligence models, and train and execute, on the at least one computing device, an artificial intelligence model that is configured to perform the task.

### CROSS-REFERENCE TO RELATED APPLICATIONS

This application claims the benefit of U.S. Provisional Application No. 63/322,308, filed Mar. 22, 3022, which is herein incorporated by reference.

### FIELD OF TECHNOLOGY

The present disclosure relates to the field of artificial intelligence, and, more specifically, to systems and methods for provisioning artificial intelligence resources.

### BACKGROUND

The use of artificial intelligence (A.I.) can be in demand in almost any area where the analysis and processing of data takes place. However, the implementation of A.I. algorithms (e.g., machine learning, deep learning, etc.) may be a rather complicated matter for both developers and end users. For example, a user may provide a dataset and may desire to utilize A.I. to extrapolate information (e.g., make predictions, classify objects, etc.). There are services provided by Microsoft™, Amazon™, Google™, and other vendors for hosting A.I. applications focused on solving such tasks. However, those services merely host the applications. There is no focus on providing recommendations to the user or guidance towards solutions based on their provided dataset. Accordingly, users are unable to identify the best A.I. models and techniques to perform their tasks. As there are many factors to consider such as the availability of required computing resources, the accuracy of models, the quality of the dataset, etc., a user may feel overwhelmed when attempting to incorporate A.I. in their data processing.

There thus exists a need for provisioning artificial intelligence resources that solve the tasks set by the user in a processing, time, and storage efficient manner.

### SUMMARY

In one exemplary aspect, the techniques described herein relate to a method for provisioning artificial intelligence resources, the method including: receiving an input training dataset and an indication of a task to perform using the input training dataset; determining a size of the input dataset and a content type of an entry in the input training dataset; identifying, from a plurality of computing resources, at least one computing resource to accommodate the size and the content type associated with the input training dataset; identifying attributes of the input training dataset; selecting, from a plurality of artificial intelligence models, an artificial intelligence model that is configured to perform the task and is compatible with the attributes of the input training dataset; training, on the at least one computing resource, the artificial intelligence model to perform the task using the input training dataset; and executing, on the at least one computing resource, the trained artificial intelligence model to perform the task.

In some aspects, the techniques described herein relate to a method, wherein the plurality of computing resources are computing devices each with different memory, storage, networking, and processing capabilities.

In some aspects, the techniques described herein relate to a method, further including prior to receiving the input training dataset: identifying respective storage limits of each of the plurality of computing resources; and identifying respective processing and networking limits of each of the plurality of computing resources.

In some aspects, the techniques described herein relate to a method, wherein the indication of the task further includes a time limit for performing the task.

In some aspects, the techniques described herein relate to a method, wherein identifying the at least one computing resource to accommodate the size and the content type is in response to determining that a storage limit of the at least one computing resource exceeds the size and the processing and network limits enable successful completion of the task within the time limit.

In some aspects, the techniques described herein relate to a method, wherein identifying the at least one computing resource to accommodate the size and the content type is in response to determining that the at least one computing resource can store the input training dataset and is compatible with the content type.

In some aspects, the techniques described herein relate to a method, wherein the attributes include one or more of: (1) dimensions of the entry in the input training dataset, (2) a number of input values in an entry, (3) a number of output values in an entry, (4) a number of unique output values in the input training dataset, and (5) a balance between the unique output values.

In some aspects, the techniques described herein relate to a method, further including: amending code associated with the artificial intelligence model to accommodate structure differences between the input training dataset and a native training dataset used to train the artificial intelligence model.

In some aspects, the techniques described herein relate to a method, wherein the indication of the task further includes a target error rate, further including: determining whether an error rate of the trained artificial intelligence model is greater than the target error rate; and in response to determining that the error rate of the trained artificial intelligence model is greater than the target error rate, re-training the trained artificial intelligence model.

In some aspects, the techniques described herein relate to a method, further including: in response to determining that an error rate of the re-trained artificial intelligence model is greater than the target error rate, selecting, from the plurality of artificial intelligence models, a different artificial intelligence model that is configured to perform the task and is compatible with the attributes of the input training dataset; and training, using the input training dataset, the different artificial intelligence model to perform the task at an error rate not greater than the target error rate.

In some aspects, the techniques described herein relate to a method, further including: generating a report that indicates errors made by the trained artificial intelligence model.

It should be noted that the methods described above may be implemented in a system comprising a hardware processor. Alternatively, the methods may be implemented using computer executable instructions of a non-transitory computer readable medium.

In some aspects, the techniques described herein relate to a system for provisioning artificial intelligence resources, including: a memory; and a hardware processor communicatively coupled with the memory and configured to: receive an input training dataset and an indication of a task to perform using the input training dataset; determine a size of the input dataset and a content type of an entry in the input training dataset; identify, from a plurality of computing resources, at least one computing resource to accommodate the size and the content type associated with the input training dataset; identify attributes of the input training dataset; select, from a plurality of artificial intelligence models, an artificial intelligence model that is configured to perform the task and is compatible with the attributes of the input training dataset; train, on the at least one computing resource, the artificial intelligence model to perform the task using the input training dataset; and execute, on the at least one computing resource, the trained artificial intelligence model to perform the task.

In some aspects, the techniques described herein relate to a non-transitory computer readable medium storing thereon computer executable instructions for provisioning artificial intelligence resources, including instructions for: receiving an input training dataset and an indication of a task to perform using the input training dataset; determining a size of the input dataset and a content type of an entry in the input training dataset; identifying, from a plurality of computing resources, at least one computing resource to accommodate the size and the content type associated with the input training dataset; identifying attributes of the input training dataset; selecting, from a plurality of artificial intelligence models, an artificial intelligence model that is configured to perform the task and is compatible with the attributes of the input training dataset; training, on the at least one computing resource, the artificial intelligence model to perform the task using the input training dataset; and executing, on the at least one computing resource, the trained artificial intelligence model to perform the task.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for provisioning artificial intelligence resources.

FIG. 2A is a diagram of a user interface that receives user preferences for an artificial intelligence algorithm.

FIG. 2B is a diagram of a user interface that displays information about a selected computing resource and a selected artificial intelligence algorithm.

FIG. 2C is a diagram of a user interface that displays an output of a trained artificial intelligence algorithm.

FIG. 3 illustrates a flow diagram of a method for provisioning artificial intelligence resources.

FIG. 4 presents an example of a general-purpose computer system on which aspects of the present disclosure can be implemented.

### DETAILED DESCRIPTION

Exemplary aspects are described herein in the context of a system, method, and computer program product for provisioning artificial intelligence (AI) resources. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

To resolve the shortcomings described in the background, the present disclosure describes systems and methods for provisioning A.I. resources. The proposed solution provides hosting of complex A.I. services that allow users to work with any provided data and solve user-defined tasks. Implementation of the proposed solution involves evaluating the required computing resources (e.g., depending on the amount of data, what storage is needed, what computing device to use, whether to user virtual machines, etc.). The implementation further involves assessment of the provided data (e.g., balance of the dataset, analysis of the quality of the dataset and proposed solutions). The implementation further involves providing A.I algorithms and tailoring (e.g., cleaning/ordering) the data based on the requirements of the A.I. algorithms, the assessment of the provided data, and the identification of computing resources. Lastly, the implementation involves monitoring the service, collecting feedback, and analyzing false positives.

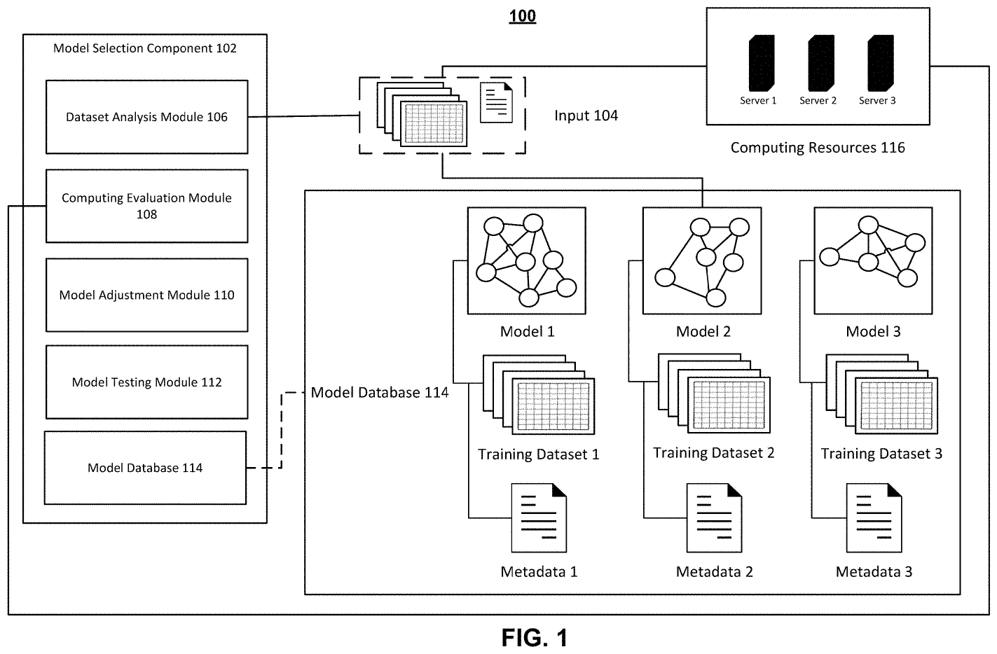

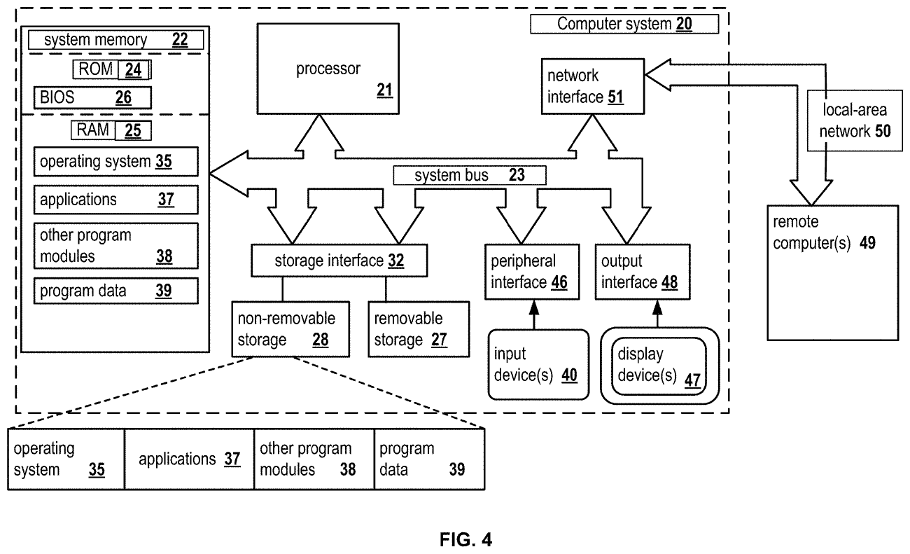

FIG. 1 is a block diagram illustrating system 100 for provisioning artificial intelligence resources. System 100 includes model selection component 102, which may be a software installed on a computer system (e.g., computer system 20 of FIG. 4). A hardware processor may execute model selection component 102.

Model selection component 102 may include a plurality of modules, namely: dataset analysis module 106, computing evaluation module 108, model adjustment module 110, model testing module 112, and model database 114. In some aspects, model selection component 102 may be split as a thick and thin client application. The thin client application may run on a computing device such as a smartphone or laptop and the thick client application may run on a different computing device such as a server. The thin client application may be configured to receive input 104 via a graphical user interface and transmit the contents of input 104 to the thick client application. The thick client application may execute the plurality of modules to identify an artificial intelligence model and at least one computing resource from computing resources 116 that can process input 104.

Input 104 represents a training dataset and its corresponding metadata that a user would like to be processed by an artificial intelligence model. In some aspects, the artificial intelligence model is a machine learning model or a deep learning model (e.g., a neural network). In FIG. 1, there are three example artificial intelligence models in database 114. One skilled in the art will appreciate that only three examples are given for simplicity, but any number of models may be stored in database 114. In some aspects, the artificial intelligence models are stored as executable files. In other aspects, the artificial intelligence models are stored as a collection of files including code, text files including learned weights, and any libraries needed to execute the code. In other aspects, the artificial intelligence models are stored as containers with all the necessary files needed to run the trained models. Each model is accompanied by a native training dataset that was originally used to train the artificial intelligence model by a developer of the model. A native training dataset may be one that was used to generate the learned weights of a given artificial intelligence model. Each model is further accompanied by metadata, which may include information about the model type (e.g., classification, regression, decision tree, etc.), input vector dimensions (e.g., 300×300), output vector dimensions (e.g., 1×2), size of training dataset (e.g., 10,000 images), training functions utilized (e.g., Adaboost, gradient descent, etc.), name of developer, etc. In some aspects, the model may be a neural network and the metadata may further specify the number of layers/neurons, and the functions used in each layer (e.g., max pooling, sigmoid, convolution, etc.).

Computing resources 116 includes a plurality of servers, computers, storage devices, etc., that each have different capabilities in terms of processing, memory, storage, and networking. For example, server 1 may have the following specifications: two 3rd Generation Intel™ Xeon™ Scalable processors (with 40 cores per processor), 32 DDR4 DIMM slots, storage of eight 2.5-inch NVMe (SSD) each with a storage limit of 122.88 TB, and a Broadcom 57504 Quad Port 10/25 GbE, SFP28, OCP NIC 3.0. Server 2 may be a variant of server 1 with one processor, fewer total cores, fewer DIMM slots, and a lower storage limit, and an older network card. Accordingly, server 1 is the more capable computing resource relative to server 2 in computing resources 116. While some tasks that a user intends to perform are capable of being met by server 2, beyond a certain limit, server 1 is a better option to select for provisioning artificial intelligence resources. In some cases, however, other users may be utilizing computing resources 116—specifically server 1, in which case server 2 may be the second best option to recommend to the user for performing a task.

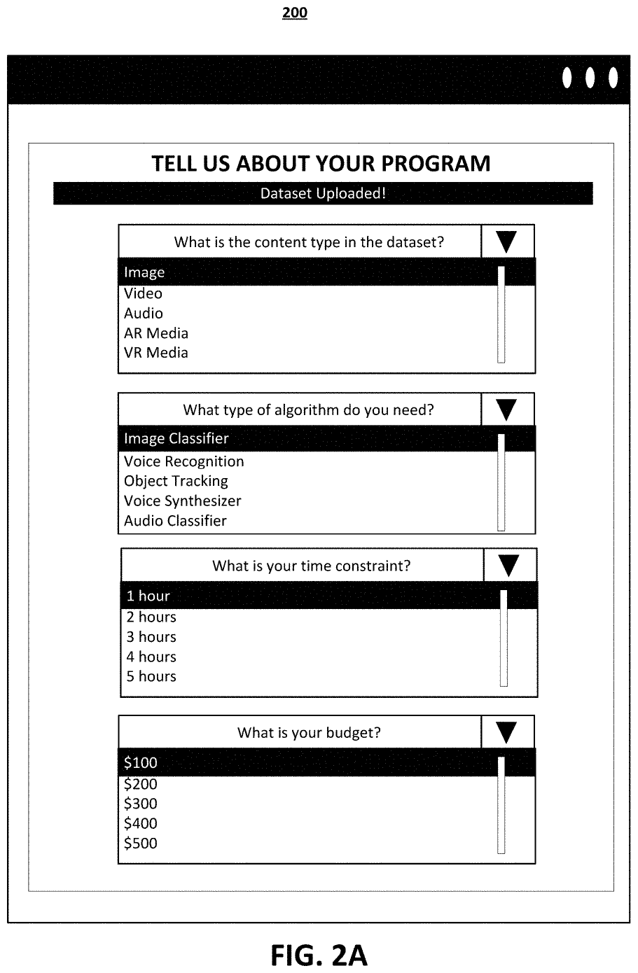

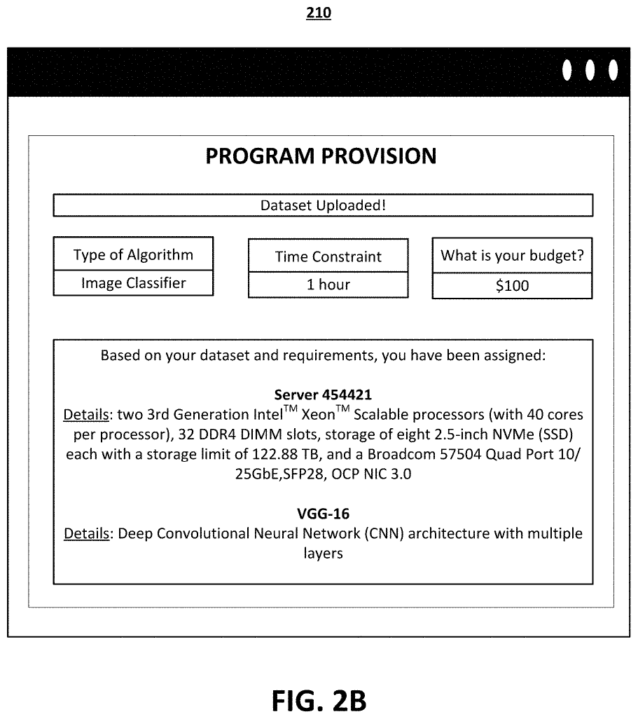

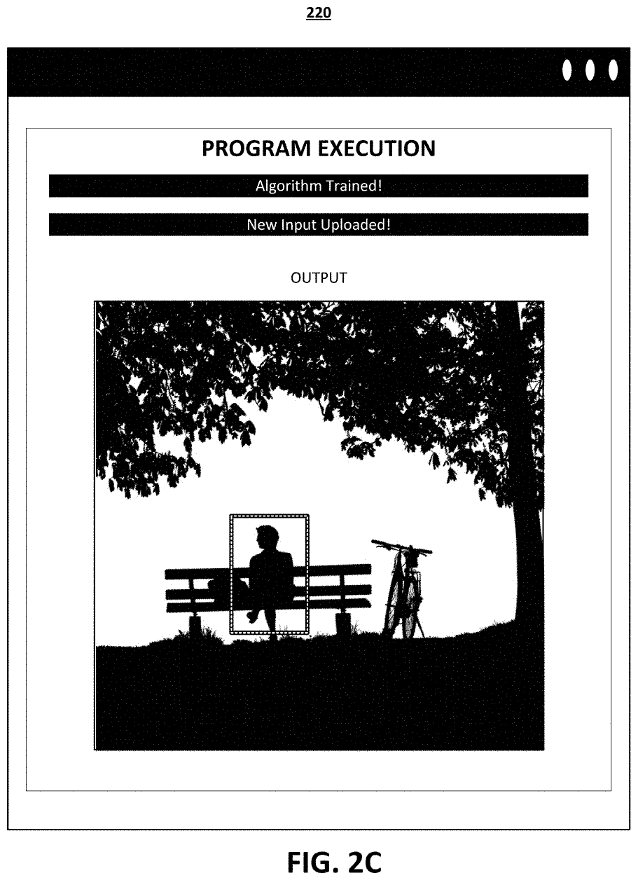

FIG. 2A is diagram 200 of a user interface that receives user preferences for an artificial intelligence algorithm. The user interface is generated by model selection component 102 to query the preferences of the user (e.g., for a type of algorithm or computing resource). In some aspects, the user interface may receive the input training dataset from the user and subsequent to uploading the dataset, the user interface may output questions. For example, the first question asks what the content type is in the dataset.

The second question asks for the type of algorithm the user is seeking to use. The third question asks for a time constraint (if any) and the fourth question asks for a budget (if any). In some aspects, each of these questions may be provided with a plurality of options. For example, the second question is provided with the options: image classifier, voice recognition, object tracking, etc. It should be noted that the possible options are not limited to just the options shown in FIG. 2A. Suppose that on the user interface of FIG. 2A, the user selects image, image classifier, 1 hour, and $100 for each of the questions, respectively.

Consider an example in which the user has uploaded a training dataset including a plurality of images and an output class. In particular, the user may be interested in identifying a person in an arbitrary image. This identification may involve generating a boundary box around a detected person. The training dataset may be constructed such that each image is defined in a one-dimensional vector (e.g., each image may be converted into grayscale and the two-dimensional matrix may be collapsed into a one-dimensional vector that can be reconstructed into the two-dimensional matrix). Because the content type is selected as “image,” model selection component 102 is able to determine that despite an individual vector being one-dimensional, the input is an image. Each image vector in the training dataset may be accompanied with an output vector that includes the dimensions of a boundary box and its center point. The center point is used to locate a detected person and the dimensions are used to bound the person within a box.

Based on this training dataset, dataset analysis module 106 may identify a model with a similar training dataset, a matching content type, and a matching algorithm type. For example, model 1 may be a convolution neural network known as VGG-16, which is an image classifier applied on images. Dataset analysis module 106 may determine that VGG-16 is an image classifier (which is the selected type of the user) and that the training dataset 1 is structurally the same as the input training dataset (e.g., same image size, output vector, etc.). Based on this similarity in type and training dataset structure, model selection component 102 may select model 1 as the algorithm to recommend to the user. In some aspects, model selection component 102 may recommend a plurality of algorithms to the user (if multiple algorithms match the user preferences).

Computing evaluation module 108 may then evaluate the monetary and time-based requirements of the user. For each of computing resources 116, for example, computing evaluation module 108 may determine an amount of time and cost for training and executing the recommended algorithms (e.g., VGG-16) with the providing training dataset. The amount of time and cost is directed affected by the size of the training dataset and the content type. For example, a small training dataset that solely has text will take less time to implement than a relatively larger training dataset that includes video. Computing evaluation module 108 may then recommend the computing resources that meet the user preferences.

It should be noted that the monetary and time-based preferences of the user may conflict with one another. For example, the user may request an extremely short turnaround time and set an equally low budget. The budget of the user may warrant using a CPU to train an algorithm such as VGG-16. However, using a CPU may cause for the amount of time it takes to train the algorithm to exceed the time constraint. In order to meet the time constraint, a GPU may be needed (although the GPU may be more costly as a cloud computing resource). In these situations, if computing evaluation module 108 cannot satisfy both criteria, then computing evaluation module 108 may recommend all of the computing resources that meet at least one of the preferences.

FIG. 2B is diagram 210 of a user interface that displays information about a selected computing resource and a selected artificial intelligence algorithm. For example, after performing an analysis of all models and computing resources, model selection component 102 may recommend using “server 454421” and “VGG-16.”

In some aspects, once a computing resource has been assigned to a user, no other users may access that resource. Accordingly, when determining which computing resource to recommend, model selection component 102 also considers resource availability. Suppose that model selection component 102 determines that a certain computing resource is appropriate for a user's training dataset and purpose. If that computing resource is determined to be unavailable (e.g., another user is using the computing resource, the server is down for maintenance, the server is rebooting, etc.), model selection component 102 may estimate a time until the computing resource will be available. For example, model selection component 102 may determine that the computing resource will reboot in 5 minutes. Model selection component 102 may factor this downtime into the evaluation of the computing resource. For example, the time constraint of the user may be 2 hours. If in addition to the downtime, the amount of time to train and execute the algorithm will be less than that time, model selection component 102 may select that computing resource for usage (even though the computing resource is not immediately available).

FIG. 2C is diagram 220 of a user interface that displays an output of a trained artificial intelligence algorithm. In diagram 220, the image classifier has been trained and is provided with an arbitrary input image. As discussed previously, the user may wish to identify people in images. Accordingly, diagram 220 depicts the sole person in the image being highlighted with a boundary box.

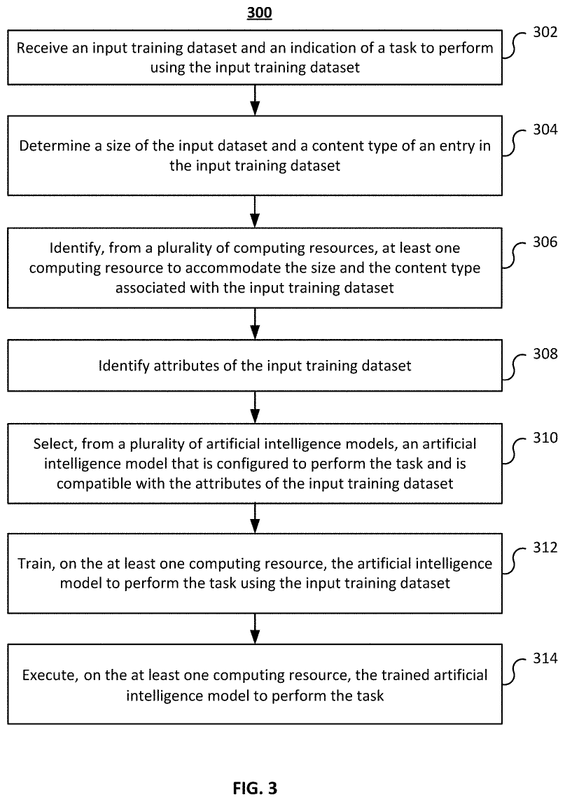

FIG. 3 illustrates a flow diagram of method 300 for provisioning artificial intelligence resources. At 302, model selection component 102 receives an input training dataset and an indication of a task to perform using the input training dataset (e.g., as part of input 104). For example, model selection component 102 may generate a graphical user interface where a user may upload the input training dataset and provide a description of the task. Suppose that the input training dataset includes a plurality of images of cars and the user would like to classify whether an image has a car or not. The task may be described using text, selectable options, speech, gestures, etc. In some aspects, a selectable option may query whether the user is attempting to classify objects in an image, predict futures values based on historic data, mimic behavior of a user based on user data, etc. In some aspects, the indication of the task further includes a time limit for performing the task (e.g., 2 hours to develop a trained image classifier).

At 304, dataset analysis module 106 may determine a size of the input dataset and a content type of an entry in the input training dataset. For example, the input training dataset may include 10,000 entries and the content type may be images. Other content types may include, but are not limited to, video, text, speech, gaming, virtual reality content, augmented reality content, and map data.

At 306, computing evaluation module 108 may identify, from a plurality of computing resources (e.g., computing resources 116), at least one computing resource (e.g., server 1) to accommodate the size and the content type associated with the input training dataset. In the context of the present disclosure, “accommodating’ specifically means to enable the successful completion of the task given any user constraints (e.g., time limits, accuracy, etc.) without any software or hardware failures (e.g., crashes).

In some aspects, prior to receiving the input training dataset, model selection component 102 may identify respective storage limits of each of the plurality of computing resources and identify respective processing and networking limits of each of the plurality of computing resources. Accordingly, computing evaluation module 108 identifies the at least one computing resource to accommodate the size and the content type in response to determining that a storage limit of the at least one computing resource exceeds the size of the input training dataset and the processing and network limits enable successful completion of the task within the time limit. For example, based on the size of the dataset, attributes of a selected model (e.g., number of layers, neurons, etc.), the processing speed, the upload/download speeds, and the training method (e.g., stochastic gradient descent), model selection component 102 may estimate a time to complete the task by a given computing resource. Model selection component 102 may then compare the time to the time limit and select the computing resource in response to determining that the time is less than or equal to the time limit.

In some aspects, model selection component 102 may identify the at least one computing resource to accommodate the size and the content type in response to determining that the at least one computing resource can store the input training dataset and is compatible with the content type. The compatibility in this context refers to whether the software of the computing resource can support a particular model or input training dataset. For example, if server 1 is not compatible with certain MacOS based files, and the input training dataset includes such incompatible files, model selection component 102 will not select server 1.

At 308, dataset analysis module 106 identifies attributes of the input training dataset. In some aspects, the attributes comprise one or more of: (1) dimensions of the entry in the input training dataset, (2) a number of input values in an entry, (3) a number of output values in an entry, (4) a number of unique output values in the input training dataset, and (5) a balance between the unique output values.

At 310, model selection component 102 selects, from a plurality of artificial intelligence models (e.g., in model database 114), an artificial intelligence model that is configured to perform the task and is compatible with the attributes of the input training dataset. For example, if the task involves classifying objects in an image, model selection component 102 may select a model that is an image classifier (e.g., model 1). If the task involves speech recognition, model selection component 102 may select a different model catered to natural language processing (e.g., model 2). If the task involves predicting numerical values based on historic data, model selection component 102 may select a regression-based model (e.g., model 3).

Because there may be multiple models of a certain type (e.g., different versions of the “image classifier” type), model selection component 102 may further evaluate whether the model is compatible with the input training dataset. Some models may, for example, accept only a single size input vector (e.g., a 300×300 image). Some models may, for example, need a specific number of training entries to achieve a level of accuracy. Some models may, for example, need a certain balance of entries. For example, if the user sets a task to classify abnormal computer behavior and provides a dataset with a majority “normal” labelled entries, a normal Bayesian classifier may not be as effective as a one-class support vector machine model.

At 312, model testing module 112 trains, on the at least one computing resource (e.g., server 1), the artificial intelligence model (e.g., model 1) to perform the task using the input training dataset. For example, model 1 may be an image classifying neural network (e.g., VGG-19) and model testing module 112 may train the model using images in the input training dataset.

At 314, model testing module 112 may execute, on the at least one computing resource, the trained artificial intelligence model to perform the task (e.g., classify cars in arbitrary input images). In some aspects, model selection component 102 may test the re-trained machine learning module with a testing dataset. In some aspects, the testing dataset is a portion of the training dataset that is isolated from the training dataset prior to re-training.

In some aspects, model selection component 102 may generate a report that indicates errors made by the trained artificial intelligence model. For example, the user may receive, via a graphical user interface of model selection component 102, a report that includes information about false positives, false negatives, an error rate, a training time, etc.

In some aspects, the indication of the task further includes a target error rate (e.g., 1%). Model testing module 112 may determine whether an error rate (e.g., 2%) of the trained artificial intelligence model (e.g., model 1) is greater than the target error rate. In response to determining that the error rate of the trained artificial intelligence model is greater than the target error rate, model testing module 112 re-trains the trained artificial intelligence model.

In some aspects, in response to determining that an error rate of the re-trained artificial intelligence model is greater than the target error rate, model testing module 112 selects, from the plurality of artificial intelligence models, a different artificial intelligence model (e.g., model 2) that is configured to perform the task and is compatible with the attributes of the input training dataset. Model testing module 112 may then train, using the input training dataset, the different artificial intelligence model to perform the task at an error rate not greater than the target error rate.

In some aspects, module adjustment module 110 may amend code associated with the artificial intelligence model to accommodate structure differences between the input training dataset and a native training dataset used to train the artificial intelligence model. For example, if an image in the input training dataset has a size of 500×500 and an image in the native training dataset has a size of 512×512, model adjustment module 110 may add code that adjusts the size of the images in the input training dataset to 512×512. The added code may crop, upsample, downsample, etc., images to resolve differences between the respective training datasets. In some aspects, model adjustment module 110 may change the code of the machine learning model by adjusting the weight vector size to match the sizes of the images in the first training dataset. Thus, if the machine learning model is conventionally written to receive images of size 512×512, the machine learning model can now accommodate images of size 500×500.

FIG. 4 is a block diagram illustrating a computer system 20 on which aspects of systems and methods for provisioning artificial intelligence resources may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-3 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for provisioning artificial intelligence resources, the method comprising:
receiving an input training dataset and an indication of a task to perform using the input training dataset;
determining a size of the input dataset and a content type of an entry in the input training dataset;
identifying, from a plurality of computing resources, at least one computing resource to accommodate the size and the content type associated with the input training dataset;
identifying attributes of the input training dataset;
selecting, from a plurality of artificial intelligence models, an artificial intelligence model that is configured to perform the task and is compatible with the attributes of the input training dataset;
training, on the at least one computing resource, the artificial intelligence model to perform the task using the input training dataset; and
executing, on the at least one computing resource, the trained artificial intelligence model to perform the task.

2. The method of claim 1, wherein the plurality of computing resources are computing devices each with different memory, storage, networking, and processing capabilities.

3. The method of claim 1, further comprising prior to receiving the input training dataset:
identifying respective storage limits of each of the plurality of computing resources; and
identifying respective processing and networking limits of each of the plurality of computing resources.

4. The method of claim 3, wherein the indication of the task further includes a time limit for performing the task.

5. The method of claim 4, wherein identifying the at least one computing resource to accommodate the size and the content type is in response to determining that a storage limit of the at least one computing resource exceeds the size and the processing and network limits enable successful completion of the task within the time limit.

6. The method of claim 1, wherein identifying the at least one computing resource to accommodate the size and the content type is in response to determining that the at least one computing resource can store the input training dataset and is compatible with the content type.

7. The method of claim 1, wherein the attributes comprise one or more of:
(1) dimensions of the entry in the input training dataset,
(2) a number of input values in an entry,
(3) a number of output values in an entry,
(4) a number of unique output values in the input training dataset, and
(5) a balance between the unique output values.

8. The method of claim 1, further comprising:
amending code associated with the artificial intelligence model to accommodate structure differences between the input training dataset and a native training dataset used to train the artificial intelligence model.

9. The method of claim 1, wherein the indication of the task further includes a target error rate, further comprising:
determining whether an error rate of the trained artificial intelligence model is greater than the target error rate; and
in response to determining that the error rate of the trained artificial intelligence model is greater than the target error rate, re-training the trained artificial intelligence model.

10. The method of claim 9, further comprising:
in response to determining that an error rate of the re-trained artificial intelligence model is greater than the target error rate, selecting, from the plurality of artificial intelligence models, a different artificial intelligence model that is configured to perform the task and is compatible with the attributes of the input training dataset; and
training, using the input training dataset, the different artificial intelligence model to perform the task at an error rate not greater than the target error rate.

11. The method of claim 1, further comprising:
generating a report that indicates errors made by the trained artificial intelligence model.

12. A system for provisioning artificial intelligence resources, comprising:
a memory; and
a hardware processor communicatively coupled with the memory and configured to:
receive an input training dataset and an indication of a task to perform using the input training dataset;
determine a size of the input dataset and a content type of an entry in the input training dataset;
identify, from a plurality of computing resources, at least one computing resource to accommodate the size and the content type associated with the input training dataset;
identify attributes of the input training dataset;
select, from a plurality of artificial intelligence models, an artificial intelligence model that is configured to perform the task and is compatible with the attributes of the input training dataset;
train, on the at least one computing resource, the artificial intelligence model to perform the task using the input training dataset; and
execute, on the at least one computing resource, the trained artificial intelligence model to perform the task.

13. The system of claim 12, wherein the plurality of computing resources are computing devices each with different memory, storage, networking, and processing capabilities.

14. The system of claim 12, wherein the hardware processor is further configured to prior to receiving the input training dataset:
identify respective storage limits of each of the plurality of computing resources; and
identify respective processing and networking limits of each of the plurality of computing resources.

15. The system of claim 14, wherein the indication of the task further includes a time limit for performing the task.

16. The system of claim 15, wherein the hardware processor is further configured to identify the at least one computing resource to accommodate the size and the content type in response to determining that a storage limit of the at least one computing resource exceeds the size and the processing and network limits enable successful completion of the task within the time limit.

17. The system of claim 12, wherein the hardware processor is further configured to identify the at least one computing resource to accommodate the size and the content type in response to determining that the at least one computing resource can store the input training dataset and is compatible with the content type.

18. The system of claim 12, wherein the attributes comprise one or more of:
(1) dimensions of the entry in the input training dataset,
(2) a number of input values in an entry,
(3) a number of output values in an entry,
(4) a number of unique output values in the input training dataset, and
(5) a balance between the unique output values.

19. The system of claim 12, wherein the hardware processor is further configured to:
amend code associated with the artificial intelligence model to accommodate structure differences between the input training dataset and a native training dataset used to train the artificial intelligence model.

20. A non-transitory computer readable medium storing thereon computer executable instructions for provisioning artificial intelligence resources, including instructions for:
receiving an input training dataset and an indication of a task to perform using the input training dataset;
determining a size of the input dataset and a content type of an entry in the input training dataset;
identifying, from a plurality of computing resources, at least one computing resource to accommodate the size and the content type associated with the input training dataset;
identifying attributes of the input training dataset;
selecting, from a plurality of artificial intelligence models, an artificial intelligence model that is configured to perform the task and is compatible with the attributes of the input training dataset;
training, on the at least one computing resource, the artificial intelligence model to perform the task using the input training dataset; and
executing, on the at least one computing resource, the trained artificial intelligence model to perform the task.
